(19) United States
(12) Patent Application Publication
(10) Pub. No.: US 2026/0075520 A1
(43) Pub. Date: Mar. 12, 2026

(54) PREDICTION-BASED LATENCY AWARE POWER SAVING USING ADAPTIVE TARGET WAKE TIME (TWT)

(71) Applicant: QUALCOMM Incorporated, San Diego, CA (US)

(72) Inventor: Nirav Nayan SHAH, Bangalore (IN)

(21) Appl. No.: 18/829,025

(22) Filed: Sep. 9, 2024

(51) Int. Cl. H04W 52/02

(52) U.S. Cl. CPC H04W 52/0216

(57) ABSTRACT

This disclosure provides methods, components, devices, and systems for prediction-based latency aware power saving using adaptive target wake time (TWT). Some aspects more specifically relate to aligning traffic flows from multiple applications by using next expected times for packet transmissions, latency threshold values, processing times, and statistics to determine a next TWT. The next TWT may be communicated from a wireless device to a companion device. The wireless device may enter a sleep mode until the next TWT.

### TECHNICAL FIELD

This disclosure relates generally to wireless communication and, more specifically, to prediction-based latency aware power saving using adaptive target wake time (TWT).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented by a method for wireless communications at a wireless device. The method may include transmitting an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and transmitting or receiving at least the first data or the second data in accordance with the predicted wakeup time.

Another innovative aspect of the subject matter described in this disclosure can be implemented by a wireless device. The wireless device may include a processing system that includes processor circuitry and memory circuitry that stores code. The processing system may be configured to cause the wireless device to transmit an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and transmit or receive at least the first data or the second data in accordance with the predicted wakeup time.

Another innovative aspect of the subject matter described in this disclosure can be implemented by a wireless device. The wireless device may including means for transmitting an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and means for transmitting or receiving at least the first data or the second data in accordance with the predicted wakeup time.

Another innovative aspect of the subject matter described in this disclosure can be implemented by a non-transitory computer-readable medium storing code. The code may include instructions executable by one or more processors to transmit an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and transmit or receive at least the first data or the second data in accordance with the predicted wakeup time.

Some examples of the method, wireless devices, and non-transitory computer-readable medium described herein may further include operations, features, means, or instructions for receiving an end of service period (EOSP) signal that indicates that a current service period may be complete, where the predicted wakeup time may be determined in accordance with the EOSP signal.

Some examples of the method, wireless devices, and non-transitory computer-readable medium described herein may further include operations, features, means, or instructions for entering a sleep mode in accordance with the EOSP signal and waking up from the sleep mode at the predicted wakeup time.

In some examples of the method, wireless devices, and non-transitory computer-readable medium described herein, the indication of the predicted wakeup time may be included in a target wake time (TWT) information frame.

Some examples of the method, wireless devices, and non-transitory computer-readable medium described herein may further include operations, features, means, or instructions for providing an indication of a traffic flow adjustment to the first application or the second application, where the traffic flow adjustment aligns a data traffic flow timing between the first application and the second application.

Another innovative aspect of the subject matter described in this disclosure can be implemented by a method of wireless communications a wireless device. The method may include receiving an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and transmitting or receiving at least the first data or the second data in accordance with the predicted wakeup time.

Another innovative aspect of the subject matter described in this disclosure can be implemented by a wireless device including a processing system that includes processor circuitry and memory circuitry that stores code. The processing system may be configured to cause the wireless device to receive an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data, and transmit or receive at least the first data or the second data in accordance with the predicted wakeup time.

Another innovative aspect of the subject matter described in this disclosure can be implemented by a wireless device. The wireless device may include means for receiving an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data and means for transmitting or receiving at least the first data or the second data in accordance with the predicted wakeup time.

Another innovative aspect of the subject matter described in this disclosure can be implemented by a non-transitory computer-readable medium storing code. The code may include instructions executable by one or more processors to receive an indication of a predicted wakeup time in accordance with a first transmit time associated with first data from a first application adjusted by a first latency value and a second transmit time associated with second data from a second application adjusted by a second latency value, where the predicted wakeup time aligns, in time, at least the first data with the second data and transmit or receive at least the first data or the second data in accordance with the predicted wakeup time.

In some examples of the method, wireless devices, and non-transitory computer-readable medium described herein, the first latency value may be based on a local processing time associated with the first data and the second latency value may be based on a local processing time associated with the second data.

In some examples of the method, wireless devices, and non-transitory computer-readable medium described herein, the first latency value and the second latency value may be further based on a medium access latency associated with a wireless channel over which the first data and the second data may be transmitted.

In some examples of the method, wireless devices, and non-transitory computer-readable medium described herein, the predicted wakeup time may be according to a minimum value between the first transmit time adjusted by the first latency value and the second transmit time adjusted by the second latency value.

Some examples of the method, wireless devices, and non-transitory computer-readable medium described herein may further include operations, features, means, or instructions for transmitting an end of service period (EOSP) signal that indicates a current service period may be complete, where the predicted wakeup time may be determined in accordance with the EOSP signal.

In some examples of the method, wireless devices, and non-transitory computer-readable medium described herein, the indication of the predicted wakeup time may be included in a target wake time (TWT) information frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a pictorial diagram of another example wireless communication network.

FIG. 5 shows an example of a timing diagram that supports prediction-based latency aware power saving using adaptive TWT.

FIG. 6 shows an example of a flow diagram that supports prediction-based latency aware power saving using adaptive TWT.

FIG. 7 shows an example of protocol layers that support prediction-based latency aware power saving using adaptive TWT.

FIG. 8 shows a block diagram of an example wireless communication device that supports prediction-based latency aware power saving using adaptive TWT.

FIG. 9 shows a block diagram of an example wireless communication device that supports prediction-based latency aware power saving using adaptive TWT.

FIGS. 10 and 11 show flowcharts illustrating example processes performable by or at a wireless device that supports prediction-based latency aware power saving using adaptive TWT.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless device (such as, STA) may be paired with or otherwise connected to another wireless device. For example, an augmented reality or virtual reality (AR/VR) device, such as an AR/VR headset, may be connected to a companion device (such as a service access point (SAP)), and data and other information may be shared between the devices. In some examples, the AR/VR device may use split-rendering, such that the AR/VR device sends data to the companion device after an action is taken, and the companion device sends a frame back for display at the AR/VR device. A reduction in the time between sending the data and receiving the frame may correlate with an improved user experience. As such, many AR/VR applications have strict requirements for latency. For example, when a user moves while using an AR/VR headset, it is desirable that the video frames are updated quickly with minimal lag. Many of these devices are battery operated, and also have power usage requirements.

Various aspects relate generally to predicting traffic flows in order for the wireless devices to enter deeper power save modes or to stay in power save modes for longer durations. Some aspects more specifically relate to an application controlled target wake time (TWT). In some examples, data from different applications may be aligned so they can be transmitted or received together, in order to reduce the number of wake ups. Aligning data refers to sending the data together in a single service period or otherwise sending the data at a same time or within a same time period.

Traffic patterns between the wireless device and the companion device may be periodic and have some criteria on latency for each traffic flow to meet the expected user experience. This may include a 5-tuple of source IP address, source port, destination IP address, destination port, and transport protocol. For example, some traffic flows are latency sensitive, such as 6DoF (Euler Angles) Pose data, while some traffic flows have higher latency tolerance values, such as statistics and keep-alive data.

Wireless devices also may be battery powered, increasing the priority of reducing power requirements. If the application configures a latency tolerance value for each latency sensitive flow, lower protocol layers can predict the next required transmission or reception to meet the required latency. The prediction can be used to enter the deepest available power save when the traffic is periodic, which results in power savings at the wireless device. Examples described herein can be extended to other latency sensitive periodic traffic applications.

Particular aspects of the subject matter described in this disclosure can be implemented to realize one or more of the following potential advantages. In some examples, by predicting a TWT, the described techniques can be used to keep a wireless device in a power save mode for longer or to put the wireless device into a deeper power save mode. By staying in power save longer, or entering a deeper power save, the wireless device may reduce power consumption. Further, the predicted TWT may be used to aggregate data based on latency requirements, which may ensure that the user experience is improved through reducing latency times.

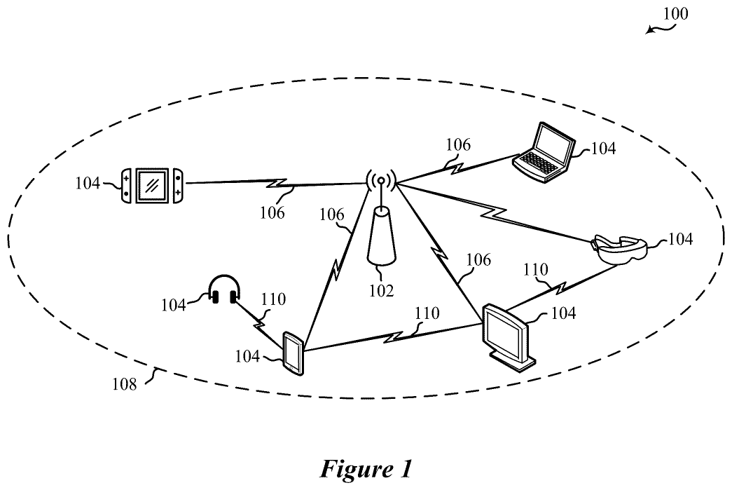

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communication network 100) may use integrated mmWave (IMMW) techniques to support operations in these frequency bands. To manage the relatively high attenuation losses and other path losses associated with the mm Wave band, the AP 102 and STAs 104 may transmit and receive directional communications via beamforming procedures. To select or otherwise generate directional beams in the mm Wave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mm Wave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mm Wave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

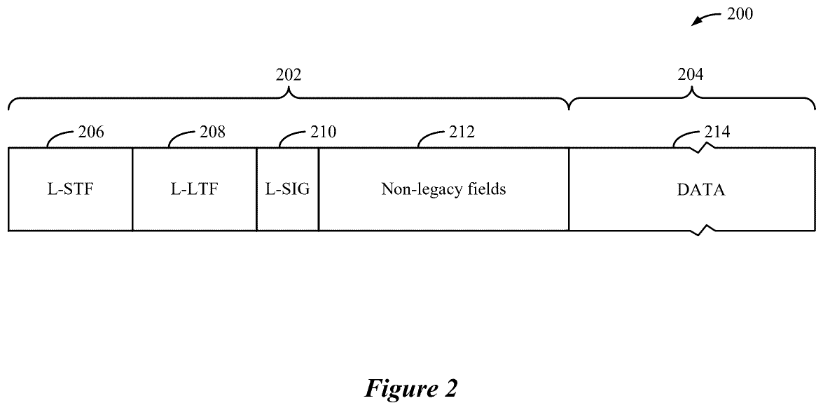

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

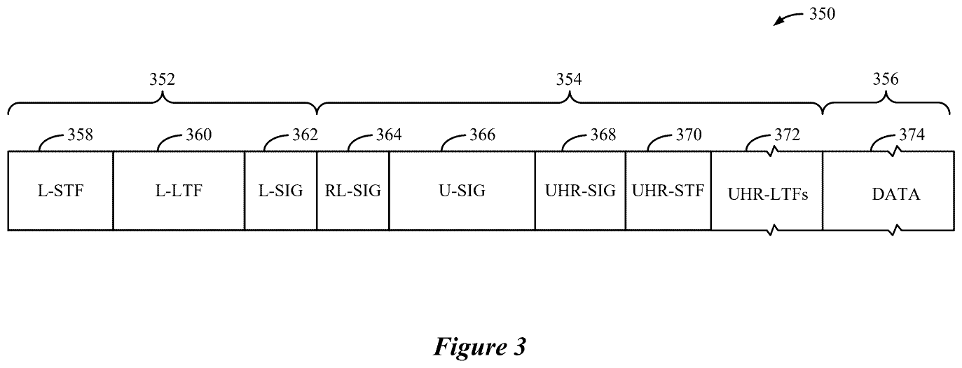

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device.

The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all rely on a copy of the data to be transmitted to the STA 104. Accordingly, the APs 102 may exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is, in some aspects, a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones (such as 24 data tones and 2 pilot tones). Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with a single radio that is shared for multiple communication links may be referred to as a multi-link single radio (MLSR) MLD. Control frames may be exchanged between MLDs before initiating data or management frame exchanges between the MLDs in implementations in which at least one of the MLDs is operating as an MLSR MLD. Because an MLD operating in the MLSR mode is limited to a single radio, it cannot use multiple communication links simultaneously and may instead listen to (such as monitor), transmit or receive on a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

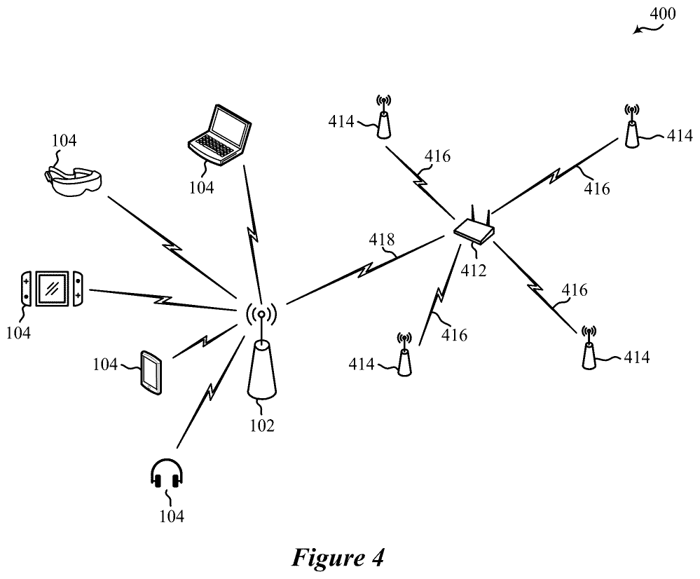

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs 102, STAs 104, or both. The wireless communication devices 414 may represent various devices such as display devices (such as TVs, computer monitors, navigation systems, AR/VR devices, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (such as audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a WLAN or a wireless (such as cellular) wide area network (WWAN), which may, in turn, provide access to external networks including the Internet. For example, the intermediate device 412 may associate and communicate, over a Wi-Fi link 418, with an AP 102 of a wireless communication network 400, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples, supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples, supporting distributed learning or distributed models, both APs and STAs may be independently capable of computing AI/ML models and sharing data with other participating wireless communication devices in the wireless communication network such that each device can train the global AI/ML model locally. In some examples, supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

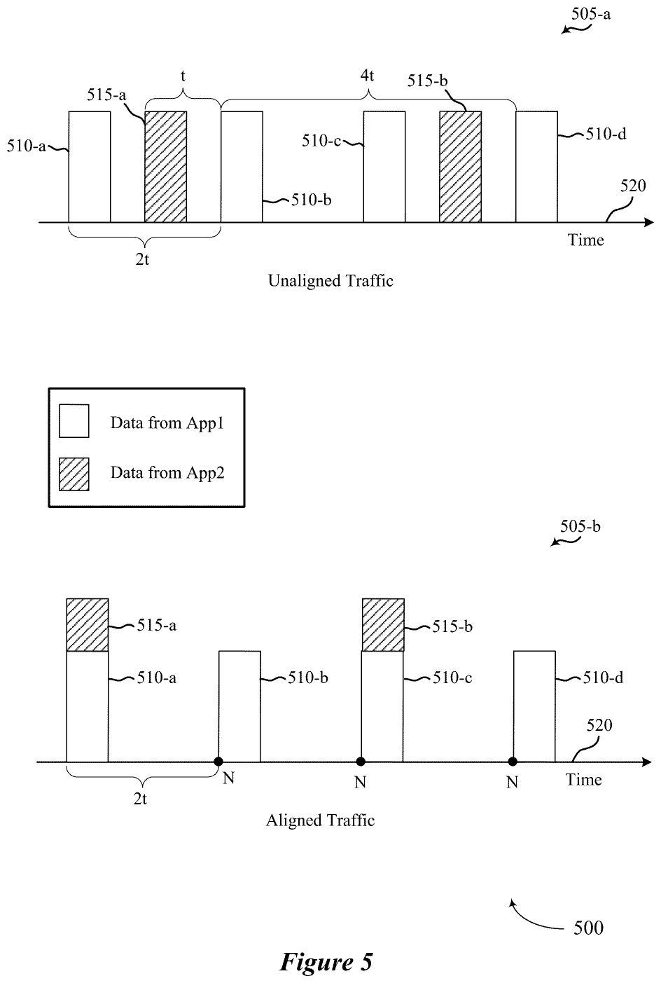

FIG. 5 shows an example of a timing diagram 500 that supports prediction-based latency aware power saving using adaptive TWT. According to some aspects, the timing diagram 500 can be implemented with multiple wireless communication devices, which in some implementations may include APs, STAs, companion devices, and other user wireless devices. The timing diagram 500 includes an example diagram 505-a with unaligned traffic and another example diagram 505-b with aligned traffic.

In some wireless systems, split-rendering Wi-Fi level power save may be implemented using latency or buffering. In For example, a number of send and receive frames are sent over the air, which allows the Wi-Fi chip to go into a lower power usage mode (such as, a listen mode). However, the lower power usage mode may be a shallow power save mode.

Alternatively, in some other wireless systems, split-rendering power save may be implemented using an application controlled target wake time (APP-TWT). TWT is a WLAN protocol feature which allows the wireless device to set up periodic wakeup and sleep cycles where a companion device is aware of the power save mode of the wireless device. TWT enables a TWT ON and a TWT OFF period, where no transmission or reception is expected during the OFF period. This enables the Wi-Fi chip on the wireless device to enter a deeper power save mode during the OFF period. However, the APP-TWT has several drawbacks.

First, the TWT schedule may be set up by an application, where each application aligns multiple traffic flows to be transmitted during the ON period. This may result in significant design changes at the application layer. Second, in some implementations, each relevant application also may readjust the TWT ON time to align its video rendering cycles due to clock drift between time sync function (TSF) of the WLAN and the local clock of the wireless device. Third, applications which use WLAN as their transport protocol may align to the same TWT schedule. This may result in a synchronization module being used at the application layer or lower layers. If the applications were to set up independent TWT schedules, this may result in no power savings. Further, WLAN is one of the transport protocol layers, and the application should be independent of transport layer functionality.

Referring to diagram 505-a, traffic is shown with data associated with two different applications over time 520. The two different applications may be application 1 (“App1” in FIG. 5) and application 2 (“App2” in FIG. 5). Application 1 may have a different latency requirement than that of Application 2. Application 1 may be associated with data 510-a through 510-d, and application 2 may be associated with data 515-a and 515-b.

Although data from only two applications are shown in this example, there can be a significant number of applications running on a wireless device. However, only some of those applications may have latency sensitive data. If traffic from the latency sensitive applications do not align, it can have a significant impact on the overall power save of the WLAN chip, because the WLAN chip may wake up multiple times to achieve the latency tolerance value for each flow.

In the example of diagram 505-a, traffic flows from the two applications are unaligned. In this example, application 1 has 60 frames per second (fps) with a 4 millisecond (ms) latency tolerance. Application 2 has 30 fps with a 4 ms latency tolerance. In some other examples, the various applications may have other values of data rates and latency tolerances. As such, in this example, the time between the start of data 510-a and data 510-b is time t. The time between the start of data 510-a and 510-b is time 2t, and the time between the start of data 510-b and 510-d is 4t.

Because the traffic flows are unaligned, the WLAN chip may have to be awake at each instance of data 510-a, 515-a, 510-b, 510-c, 515-b, and 510-d. This causes the WLAN chip to have to wake up from any sleep mode more frequently than if the traffic were aligned. This results in the WLAN chip not being able to enter as deep a sleep mode or to have shorter durations in a sleep mode. While meeting latency requirements of the applications, the wireless device may consume more power in this scenario that if it were to be in sleep mode for longer.

In contrast, diagram 505-b shows aligned traffic from application 1 and application 2. In this example, the same data 510-a, 515-a, 510-b, 510-c, 515-b, and 510-d are transmitted or received as in diagram 505-a. However, here the traffic flows are aligned such that data 510-a and data 515-a are transmitted or received at approximately the same time or within the same time duration. Likewise, data 510-c and data 515-b are aligned such that they are transmitted or received at approximately the same time or within the same time duration. Data 510-b and data 510-d are communicated separately, due to the traffic flow patterns and latency requirements of application 1.

Techniques described herein enable a WLAN component to provide an asynchronous indication to one or more of the applications to adjust their traffic such that it aligns with other latency sensitive traffic. For example, the WLAN component may signal application 2 to shape its traffic flows such that data 515-a aligns with data 510-a from application 1, and data 515-b aligns with data 510-c. By aligning these traffic flows, the wireless device may save power while still meeting any latency requirements of the applications.

There may be different examples of the indication or signal to the application to shape its traffic flow. For example, WLAN chip may send a TWT ON indication to one or more of the applications. A TWT ON indication may allow applications to align their traffic before the TWT ON time. This TWT ON indication may be used, for example, in applications where their traffic has the same or similar periodicities.

Alternatively, or additionally, the indication may be a time delta indication. The WLAN chip may indicate, to each relevant application, a specific time delta such that the traffic flows for the applications result in fewer wakeups on the WLAN chipset. The time delta indication may be used, for example, in applications where the traffic of the applications has different periodicities. In some examples, both the time delta indication and the TWT ON indication may be used together for different applications.

To achieve the prediction-based power saving described herein, one or more of the applications may configure a latency tolerance value for each latency sensitive flow. The application, or the WLAN chip, may use any of multiple approaches available for prediction of the application's next packet for a traffic flow. The WLAN module on the wireless device (such as a STA), may use the prediction and latency tolerance value of each flow to decide the time for the next transmission or reception. The WLAN module also may receive similar data from the companion device (such as a service access point (SAP)) as part of an end of service period (EOSP) indication. The WLAN module may select the minimum of both times as the next TWT wakeup time. The WLAN module may send an indication of the TWT wakeup time to each peer device through a TWT information frame.

The next wakeup time for a traffic flow of a first application, N₁, may be given in Equation 1, as an example.

$${N}_{1} = {T}_{1} + {L}_{1} - P \qquad ( 1 )$$

In equation 1, the next wakeup time, N₁, is defined as the time for the next transmit packet expected for the first flow, T₁, plus the latency tolerance of the first flow, L₁, minus an offset time P. The offset time P may be a sum of one or more of a firmware processing time, a transmission time (such as a time it takes to transmit the first flow), a medium access latency and a feedback coefficient. When using Wi-Fi to achieve the specified latency, the latency for accessing the medium may be a significant factor. Because Wi-Fi uses CSMA-CA for gaining access to the medium, the medium access latency can vary significantly based on interference and signal strength between the wireless devices. The feedback coefficient may relate to a time it takes to provide or receive feedback for the relevant data packets. As shown in Equation 1, latency feedback from peer devices to be used in deciding what next wakeup time allows the wireless device to maintain the latency tolerance value. Also, there may be feedback provided to the prediction module which may help in improving the accuracy of the next prediction. In some other examples, other latencies may be included in the offset time P. The offset time may be positive or negative, meaning that additional time may be added to or some time may be subtracted from the wakeup time.

Each application may have its own wakeup time associated with the latency specified for its respective traffic flow. For example, a second application may have a next wakeup time, N₂, a third application may have a next wakeup time, N₃, and so on. The wireless device may take all of these next wakeup times into account to perform prediction-based latency aware power saving. The next wakeup time, N, across all of the relevant applications, n, may be determined as in Equation 2.

$$N = min ( {N}_{1} , {N}_{2} , … {N}_{n} ) \qquad ( 2 )$$

As shown in FIG. 5, the next wakeup time in diagram 505-b after the data flows 510-a and 515-a, is at N when data 510-b is transmitted or received. The next wakeup time after data 510-b is at N when data 510-c and 515-b are transmitted or received. After that, the next wakeup time N is when data 510-d is transmitted or received. The determination of N may occur with every data flow, periodically, aperiodically, or as needed. Data that may be delayed in order to be aligned with other data may be buffered until the next wakeup time or a subsequent wakeup time.

Techniques described herein provide prediction-based latency aware power save modes. The techniques provide power savings by predicted when traffic flows will occur, in order to stay in a power save mode for longer or to enter a deeper power save mode. The techniques described herein further provide an indication, such as via transmitted signaling, to the applications in order to align their traffic shapes. Techniques described herein also provide feedback mechanisms to adopt to Wi-Fi medium latencies.

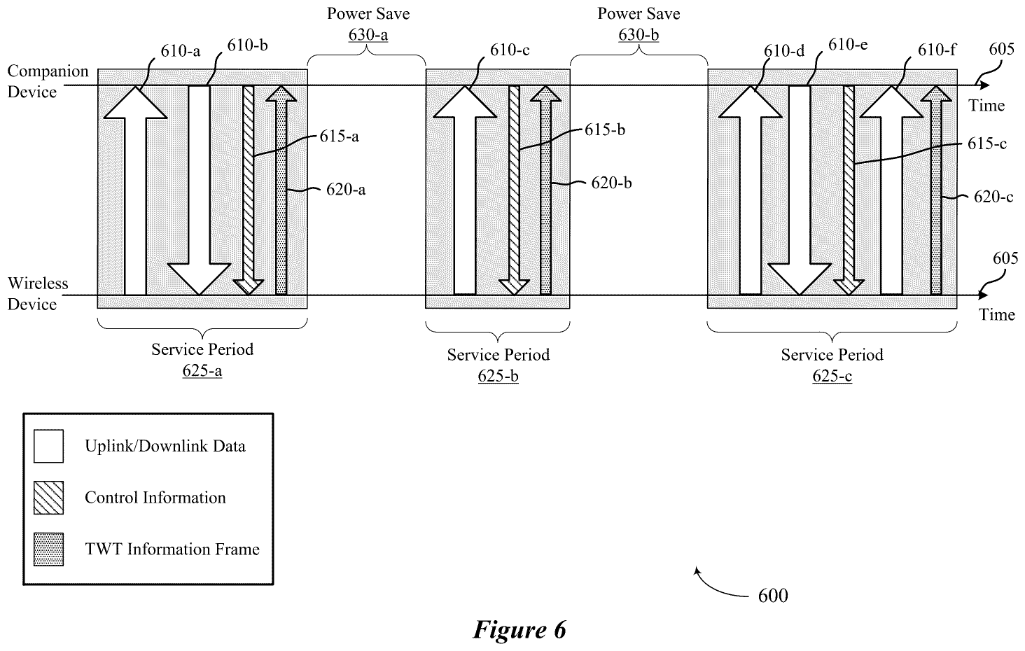

FIG. 6 shows an example of a flow diagram 600 that supports prediction-based latency aware power saving using adaptive TWT. According to some aspects, the flow diagram 600 may be implemented with multiple wireless communication devices, which in some implementations may include APs, STAs, companion devices, and other user wireless devices. The flow diagram 600 illustrates example communications between a companion device and a wireless device over time 605. The flow diagram 600 shows uplink and downlink data 610-a through 610-f (collectively referred to as data 610), control information 615-a through 615-c, and TWT information frames 620-a through 620-c.

The flow diagram 600 includes three service periods 625-a through 625-c (collectively referred to as service periods 625) and two power save periods 630-a and 630-b (collectively referred to as power save periods 630). Traffic may be transmitted or received during the service periods 625. The wireless device may be in a power save mode during the power save periods 630.

The uplink data 610-a and the downlink data 610-b may be exchanged between the wireless device and the companion device at the beginning of the service period 625-a. The control information 615-a may include or indicate, for example, an end of service period (EOSP) signal indicating an end of the downlink data 610-b during the current service period 625-a. The control information 615-a may further indicate an expected next wakeup, which may imply a latency for downlink traffic and feedback for the last packets received

One or both of the wireless device and the companion device may predict a wakeup time associated with a next service period 625-b using data flows from applications. For example, a first transmit time associated with a next expected data transmission from a first application or flow may be adjusted by a first latency value, as discussed above, to compensate for factors such as processing latency and medium access latency for the wireless channel between the wireless device and the companion device. A second transmit time associated with a next expected data transmission from a second application or flow may be adjusted by a second latency value to compensate for processing latency and medium access latency in a similar manner. The predicted next wakeup time may be ascertained using Equation 2.

The wireless device may send a TWT information frame 620-a to the companion device. The TWT information frame 620-a indicates the predicted next wakeup time to the companion device. After sending the TWT information frame 620-a, the wireless device may enter power save period 630-a. At the time indicated in the TWT information frame 620-a, the wireless device may wake up from the power save mode at the end of power save period 630-a and the next service period 625-b may begin. The time for the next wakeup period may provide an opportunity for the WLAN chip to decide a power save mode for it to enter based on the sleep-to-wake and wake-to-sleep time of each power state. The process described herein similarly may apply for the service periods 625-b and 625-c, and the power save period 630-b.

The data 610 may be aligned according to techniques described herein. Aligning the data 610 may increase the duration of the power save periods 630. Some examples may include a TSF that is a synchronized time clock between the wireless device and the companion device. Because the wireless device sends the TWT information frame 620-a to the companion device with the next start TSF, an adaptive TWT may be used, and the wireless device may not have to follow a pre-defined sleep and wake cycle. This may optimize power savings without impacting a latency tolerance value of each flow.

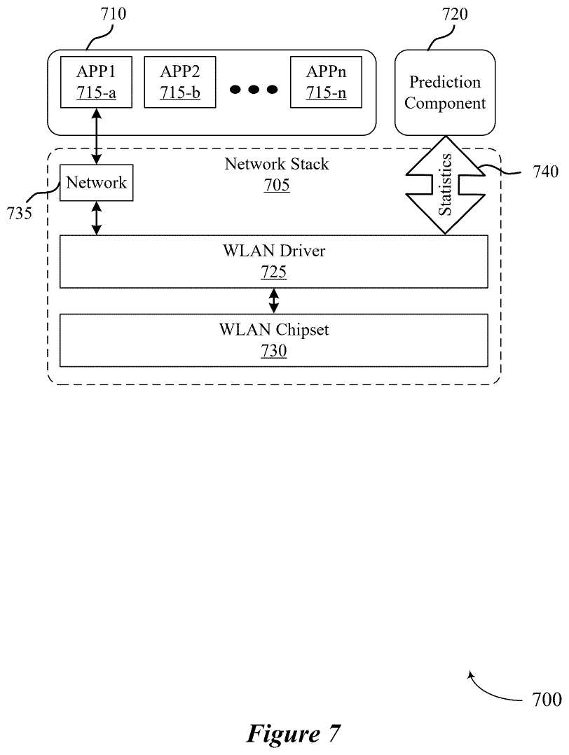

FIG. 7 shows an example of protocol layers 700 that support prediction-based latency aware power saving using adaptive TWT. According to some aspects, the protocol layers 700 may be implemented with multiple wireless communication devices, which in some implementations may include APs, STAs, companion devices, and other user wireless devices.

The example protocol layers 700 may include a network stack 705, an application layer 710, and a prediction component 720. The network stack 705 may include a network component 735 that includes a WLAN stack of a WLAN driver 725 and a WLAN chipset 730. The WLAN driver 725 may provide information to the WLAN chipset 730 regarding adaptive target wakeup times, in accordance with techniques described herein.

The application layer 710 may include n applications, application 715-a through application 715-n (collectively referred to herein as applications 715). The application layer 710 may provide data related to the timing of uplink and downlink data transfers to the network component 735. In some examples, the application layer 710 may provide latency requirements for each of the applications 715 to the network component 735.

The WLAN stack of the WLAN driver 725 and the WLAN chipset 730 also may provide statistics 740 to the prediction component 720 regarding feedback from peer device on latency observed for each flow and other parameters. The prediction component 720 may use the statistics 740 to determine an offset for a next wakeup time and provide this to the WLAN driver 725 or the WLAN chipset 730. The WLAN driver 725 or the WLAN chipset 730 may use the statistics 740 and information from the application layer 710 to determine a next adaptive target wakeup time. The next adaptive target wakeup time may be provided to the network component, which may send the information to higher or lower layers, which may result in the TWT information being included in a TWT information frame sent to the companion device.

As described herein, the use of the TWT protocol as described may allow devices to enter deeper power save modes as the device can turn off one or more of its WLAN RF chains. The adaptive TWT may be achieved by sending a TWT information frame at the end of each service period. As the wireless device does not have to follow a pre-defined periodic interval, the wakeup times may be adaptable. For example, the length of the service period may be adapted. As soon as traffic from both side are delivered, the wireless device can enter a power save mode. The next wakeup time may be dynamically adaptive and sent in the TWT information frame, such that the wireless device can stay in the power save mode for a longer period of time.

Techniques described herein may significantly reduce the complexity of an application implementation and does not require synchronization between applications. The techniques also may provide flexibility to adjust to any kind or type of traffic pattern. For example, in implementations associated with AR/VR traffic, there can be multiple flows with different periodicity, such as pose data with 45 fps and an RGB camera with 30 fps. Further, a prediction-based approach may reduce the overhead of the application which may be otherwise used to perform traffic shaping with TWT. In some examples, the application can support using an indication that can inherently align traffic with other applications. Additionally, feedback from peer devices regarding latency that may be observed for each traffic flow, in addition to other parameters, may be used to adapt the wakeup times, which may be used to ensure that the latency tolerance values are taken into consideration.

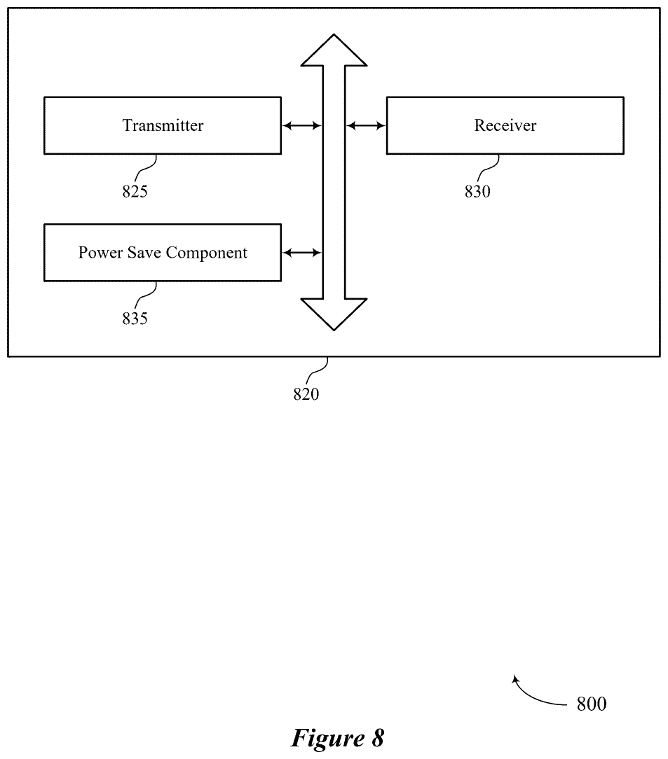

FIG. 8 shows a block diagram 800 of a wireless device 820 that supports prediction-based latency aware power saving using adaptive target TWT. The wireless device 820 may be an example of aspects of a wireless device as described with reference to FIGS. 2 through 7. The wireless device 820, or various components thereof, may be an example of means for performing various aspects of prediction-based latency aware power saving using adaptive TWT as described herein. For example, the wireless device 820 may include a transmitter 825, a receiver 830, a power save component 835, or any combination thereof. Each of these components, or components or subcomponents thereof (such as, one or more processors, one or more memories), may communicate, directly or indirectly, with one another (such as, via one or more buses).

The transmitter 825 is configurable or configured to transmit an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data. The transmitter 825 and the receiver 830 are configurable or configured to respectively transmit or receive the first data or the second data in accordance with the predicted wakeup time.

In some examples, the transmitter 825 is configurable or configured to transmit an indication of an updated predicted wakeup time in accordance with an offset, where the offset adjusts a next predicted wakeup time in accordance with a timing of the received data transmission. For example, the first latency value may be based at least in part on a local processing time associated with the first data and the second latency value may be based at least in part on a local processing time associated with the second data. Additionally, or alternatively, the first latency value and the second latency value may be further based at least in part on a medium access latency associated with a wireless channel over which the first data and the second data are transmitted. The predicted wakeup time may be determined according to a minimum value between the first transmit time adjusted by the first latency value and the second transmit time adjusted by the second latency value, such as using Equation (2) provided above.

In some examples, the receiver 830 is configurable or configured to receive an end of service period (EOSP) indication that indicates that the data transmission is complete.

In some examples, the power save component 835 is configurable or configured to enter a sleep mode in accordance with the EOSP. In some examples, the power save component 835 is configurable or configured to wake up from the sleep mode at the predicted wakeup time. The power save component 835 may be further configurable or configured to provide an indication of a traffic flow adjustment to the first application or the second application, wherein the traffic flow adjustment aligns a data traffic flow timing between the first application and the second application.

In some examples, the predicted wakeup time aligns at least first data from the first application of the set of multiple applications with second data from the second application of the set of multiple applications in accordance with a minimum of a first time determined based on a next transmit packet associated with the first application plus a first latency threshold value of the respective latency threshold values and a second time determined based on a next transmit packet associated with the second application plus a second latency threshold value of the respective latency threshold values.

In some examples, the predicted wakeup time aligns at least first data from the first application of the set of multiple applications with second data from the second application of the set of multiple applications is further in accordance with a first processing time of the first data and a second processing time of the second data.

In some examples, the indication of the predicted wakeup time is included in a TWT information frame.

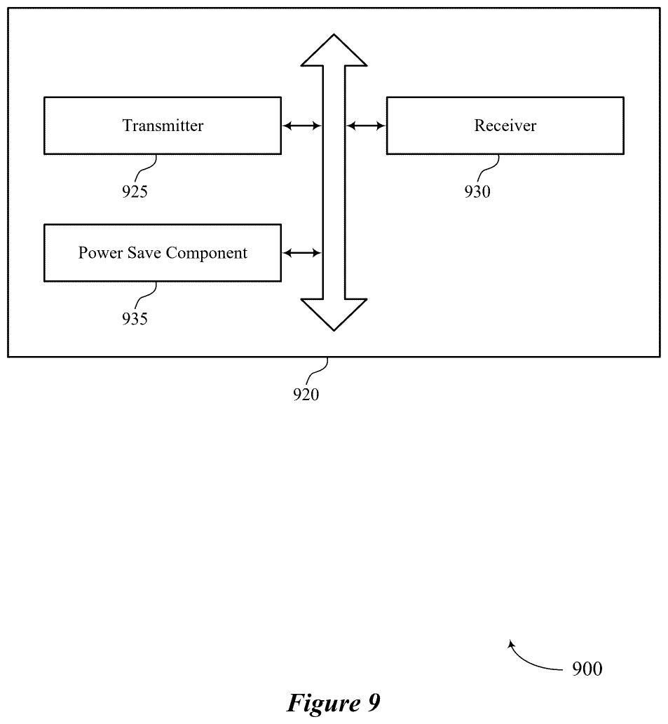

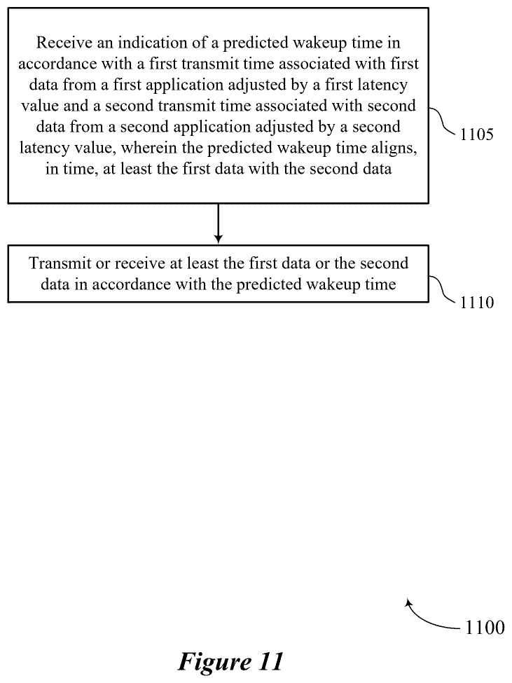

FIG. 9 shows a block diagram of an example wireless communication device 900 that supports prediction-based latency aware power saving using adaptive TWT. In some examples, the wireless communication device 900 is configured to perform the process 1100 described with reference to FIG. 11. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes a transmitter 925, a receiver 930, a power save component 935. Portions of one or more of the transmitter 925, the receiver 930, or the power save component 935 may be implemented at least in part in hardware or firmware. For example, one or more of the transmitter 925, the receiver 930, and the power save component 935 may be implemented at least in part by at least a processor or a modem. In some examples, portions of one or more of the transmitter 925, the receiver 930, and the power save component 935 may be implemented at least in part by a processor and software in the form of processor-executable code stored in memory.

The receiver 930 is configurable or configured to receive an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data. The transmitter 925 and the receiver 930 are configurable or configured to respectively transmit or receive the first data or the second data in accordance with the predicted wakeup time.

In some examples, the receiver 930 is configurable or configured to receive an indication of an updated predicted wakeup time in accordance with an offset. In some examples, the transmitter 925 is configurable or configured to transmit a second data transmission in accordance with the offset and the predicted wakeup time. For example, the first latency value may be based at least in part on a local processing time associated with the first data and the second latency value may be based at least in part on a local processing time associated with the second data. Additionally, or alternatively, the first latency value and the second latency value may be further based at least in part on a medium access latency associated with a wireless channel over which the first data and the second data are transmitted. The predicted wakeup time may be determined according to a minimum value between the first transmit time adjusted by the first latency value and the second transmit time adjusted by the second latency value, such as using Equation (2) provided above.

In some examples, the transmitter 925 is configurable or configured to transmit an EOSP signal that indicates that the data transmission is complete.

In some examples, the data transmission includes data associated with at least the first application and the second application. In some examples, the indication of the predicted wakeup time is included in a TWT information frame.

In some examples, the power save component 935 is configurable or configured to adjust data transmissions or receptions based on the TWT information. In some examples, the power save component 935 is configurable or configured to provide information to the transmitter 925 or the receiver 930 based on the TWT information, such as the control information with an EOSP signal.

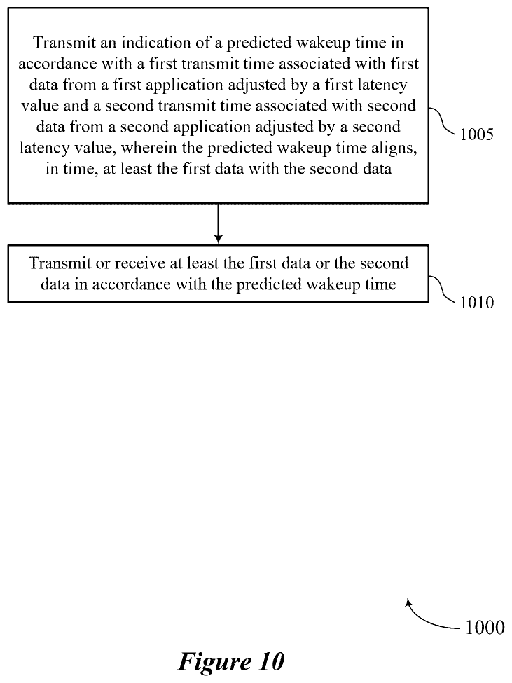

FIG. 10 shows a flowchart illustrating a method 1000 that supports prediction-based latency aware power saving using adaptive TWT. The operations of the method 1000 may be implemented by a wireless device or its components as described herein. For example, the operations of the method 1000 may be performed by a wireless device as described with reference to FIGS. 2 through 8. In some examples, a wireless device may execute a set of instructions to control the functional elements of the wireless device to perform the described functions. Additionally, or alternatively, the wireless device may perform aspects of the described functions using special-purpose hardware.

At 1005, the method may include transmitting an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data. The operations of 1005 may be performed in accordance with examples as disclosed herein. In some examples, aspects of the operations of 1005 may be performed by a transmitter 825 as described with reference to FIG. 8.

At 1010, the method may include transmitting or receiving the first data or the second data in accordance with the predicted wakeup time. The operations of 1010 may be performed in accordance with examples as disclosed herein. In some examples, aspects of the operations of 1010 may be performed by a receiver 830 as described with reference to FIG. 8.

FIG. 11 shows a flowchart illustrating an example process 1100 performable by or at a wireless device that supports prediction-based latency aware power saving using adaptive TWT. The operations of the process 1100 may be implemented by a wireless device or its components as described herein. For example, the process 1100 may be performed by a wireless communication device, such as the wireless communication device 900 described with reference to FIG. 9, operating as or within a wireless STA. In some examples, the process 1100 may be performed by a wireless STA, such as one of the STAs 104 described with reference to FIG. 1.

In some examples, in 1105, the wireless device may receive an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data. The operations of 1105 may be performed in accordance with examples as disclosed herein. In some implementations, aspects of the operations of 1105 may be performed by a receiver 930 as described with reference to FIG. 9.

In some examples, in 1110, the wireless device may transmit or receive the first data or the second data in accordance with the predicted wakeup time. The operations of 1110 may be performed in accordance with examples as disclosed herein. In some implementations, aspects of the operations of 1110 may be performed by a transmitter 925 as described with reference to FIG. 9.

Implementation examples are described in the following numbered clauses:

Aspect 1: A method for wireless communications at a wireless device, comprising: transmitting an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data; and transmitting or receiving at least the first data or the second data in accordance with the predicted wakeup time.

Aspect 2: The method of aspect 1, wherein the first latency value is based at least in part on a local processing time associated with the first data and the second latency value is based at least in part on a local processing time associated with the second data.

Aspect 3: The method of aspect 2, wherein the first latency value and the second latency value are further based at least in part on a medium access latency associated with a wireless channel over which the first data and the second data are transmitted.

Aspect 4: The method of any of aspects 1 through 3, wherein the predicted wakeup time is according to a minimum value between the first transmit time adjusted by the first latency value and the second transmit time adjusted by the second latency value.

Aspect 5: The method of any of aspects 1 through 4, further comprising: receiving an end of service period (EOSP) signal that indicates that a current service period is complete, wherein the predicted wakeup time is determined in accordance with the EOSP signal.

Aspect 6: The method of aspect 5, further comprising: entering a sleep mode in accordance with the EOSP signal; and waking up from the sleep mode at the predicted wakeup time.

Aspect 7: The method of any of aspects 1 through 6, wherein the indication of the predicted wakeup time is included in a target wake time (TWT) information frame.

Aspect 8: The method of any of aspects 1 through 7, further comprising: providing an indication of a traffic flow adjustment to the first application or the second application, wherein the traffic flow adjustment aligns a data traffic flow timing between the first application and the second application.

Aspect 9: A method for wireless communications at a wireless device, comprising: receiving an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data; and transmitting or receiving at least the first data or the second data in accordance with the predicted wakeup time.

Aspect 10: The method of aspect 9, wherein the first latency value is based at least in part on a local processing time associated with the first data and the second latency value is based at least in part on a local processing time associated with the second data.

Aspect 11: The method of any of aspects 9 through 10, wherein the first latency value and the second latency value are further based at least in part on a medium access latency associated with a wireless channel over which the first data and the second data are transmitted

Aspect 12: The method of any of aspects 9 through 11, wherein the predicted wakeup time is according to a minimum value between the first transmit time adjusted by the first latency value and the second transmit time adjusted by the second latency value.

Aspect 13: The method of any of aspects 9 through 12, further comprising: transmitting an end of service period (EOSP) signal that indicates a current service period is complete, wherein the predicted wakeup time is determined in accordance with the EOSP signal.

Aspect 14: The method of any of aspects 9 through 13, wherein the indication of the predicted wakeup time is included in a target wake time (TWT) information frame.

Aspect 15: A wireless device comprising one or more memories storing processor-executable code, and one or more processors coupled with the one or more memories and individually or collectively operable to execute the code to cause the wireless device to perform a method of any of aspects 1 through 8.

Aspect 16: A wireless device comprising at least one means for performing a method of any of aspects 1 through 8.

Aspect 17: A non-transitory computer-readable medium storing code the code comprising instructions executable by one or more processors to perform a method of any of aspects 1 through 8.

Aspect 18: A wireless device comprising one or more memories storing processor-executable code, and one or more processors coupled with the one or more memories and individually or collectively operable to execute the code to cause the wireless device to perform a method of any of aspects 9 through 14.

Aspect 19: A wireless device comprising at least one means for performing a method of any of aspects 9 through 14.

Aspect 20: A non-transitory computer-readable medium storing code the code comprising instructions executable by one or more processors to perform a method of any of aspects 9 through 14.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
one or more memories storing processor-executable code; and
one or more processors coupled with the one or more memories and individually or collectively operable to execute the code to cause the wireless device to:
transmit an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data; and
transmit or receive at least the first data or the second data in accordance with the predicted wakeup time.

2. The wireless device of claim 1, wherein the first latency value is based at least in part on a local processing time associated with the first data and the second latency value is based at least in part on a local processing time associated with the second data.

3. The wireless device of claim 2, wherein the first latency value and the second latency value are further based at least in part on a medium access latency associated with a wireless channel over which the first data and the second data are transmitted.

4. The wireless device of claim 1, wherein the predicted wakeup time is according to a minimum value between the first transmit time adjusted by the first latency value and the second transmit time adjusted by the second latency value.

5. The wireless device of claim 1, wherein the one or more processors are individually or collectively further operable to execute the code to cause the wireless device to:
receive an end of service period (EOSP) signal that indicates that a current service period is complete, wherein the predicted wakeup time is determined in accordance with the EOSP signal.

6. The wireless device of claim 5, wherein the one or more processors are individually or collectively further operable to execute the code to cause the wireless device to:
enter a sleep mode in accordance with the EOSP signal; and
wake up from the sleep mode at the predicted wakeup time.

7. The wireless device of claim 1, wherein the indication of the predicted wakeup time is included in a target wake time information frame.

8. The wireless device of claim 1, wherein the one or more processors are individually or collectively further operable to execute the code to cause the wireless device to:
provide an indication of a traffic flow adjustment to the first application or the second application, wherein the traffic flow adjustment aligns a data traffic flow timing between the first application and the second application.

9. A wireless device, comprising:
one or more memories storing processor-executable code; and
one or more processors coupled with the one or more memories and individually or collectively operable to execute the code to cause the wireless device to:
receive an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data; and
transmit or receive at least the first data or the second data in accordance with the predicted wakeup time.

10. The wireless device of claim 9, wherein the first latency value is based at least in part on a local processing time associated with the first data and the second latency value is based at least in part on a local processing time associated with the second data.

11. The wireless device of claim 9, wherein the first latency value and the second latency value are further based at least in part on a medium access latency associated with a wireless channel over which the first data and the second data are transmitted.

12. The wireless device of claim 9, wherein the predicted wakeup time is according to a minimum value between the first transmit time adjusted by the first latency value and the second transmit time adjusted by the second latency value.

13. The wireless device of claim 9, wherein the one or more processors are individually or collectively further operable to execute the code to cause the wireless device to:
transmit an end of service period (EOSP) signal that indicates a current service period is complete, wherein the predicted wakeup time is determined in accordance with the EOSP signal.

14. The wireless device of claim 9, wherein the indication of the predicted wakeup time is included in a target wake time information frame.

15. A method for wireless communications at a wireless device, comprising:
transmitting an indication of a predicted wakeup time in accordance with a first transmit time associated with first data from a first application adjusted by a first latency value and a second transmit time associated with second data from a second application adjusted by a second latency value, wherein the predicted wakeup time aligns, in time, at least the first data with the second data; and
transmitting or receiving at least the first data or the second data in accordance with the predicted wakeup time.

16. The method of claim 15, wherein the first latency value is based at least in part on a local processing time associated with the first data and the second latency value is based at least in part on a local processing time associated with the second data.

17. The method of claim 15, wherein the first latency value and the second latency value are further based at least in part on a medium access latency associated with a wireless channel over which the first data and the second data are transmitted.

18. The method of claim 15, wherein the predicted wakeup time is according to a minimum value between the first transmit time adjusted by the first latency value and the second transmit time adjusted by the second latency value.

19. The method of claim 15, further comprising:
receiving an end of service period (EOSP) signal that indicates that a current service period is complete, wherein the predicted wakeup time is determined in accordance with the EOSP signal.

20. The method of claim 15, wherein the indication of the predicted wakeup time is included in a target wake time information frame.
